(19) United States
(12) Patent Application Publication
(10) Pub. No.: US 2007/0121939 A1
(43) Pub. Date: May 31, 2007

(54) Watermarks for wireless communications

(75) Inventors: Robert Lind Olesen, Huntington, NY (US); Prabhakar R. Chitrapu, Blue Bell, PA (US); John David Kaewell, JR., Jamison, PA (US); Bing A. Chiang, Melbourne, FL (US); Richard Dan Herschaft, Whitestone, NY (US); John Erich Hoffmann, Indialantic, FL (US); Sung-Hyuk Shin, Northvale, NJ (US); Alexander Reznik, Titusville, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/542,405

(22) Filed: Oct. 3, 2006

Related U.S. Application Data
(63) Continuation-in-part of application No. 11/032,780, filed on Jan. 11, 2005.
(60) Provisional application No. 60/536,133, filed on Jan. 13, 2004.
(60) Provisional application No. 60/536,144, filed on Jan. 13, 2004.
(60) Provisional application No. 60/630,874, filed on Nov. 24, 2004.

(51) Int. Cl. H04N 7/167

(52) U.S. Cl. 380/201

(57) ABSTRACT

In a communication system comprising a plurality of transmit/receive units (TRUs), a method for embedding a watermark into data includes modifying a carrier signal containing data to embed watermark information. The modified carrier signal is transmitted. A receiver receives the modified carrier signal and extracts the watermark information from the modified carrier signal.

### CROSS REFERENCE TO RELATED APPLICATIONS

This application is a continuation-in-part of U.S. application Ser. No. 11/032,780, filed on Jan. 11, 2005, which claims the benefit of U.S. Provisional Application Nos. 60/536,133 and 60/536,144, filed on Jan. 13, 2004, and U.S. Provisional Application No. 60/630,874, filed on Nov. 24, 2004, which are incorporated herein by reference as if fully set forth.

### FIELD OF INVENTION

The present invention relates generally to wireless communications. More specifically, the present invention is directed to watermarks for wireless communications.

### BACKGROUND

Wireless systems are susceptible in many respects. These susceptibilities are increasing as new wireless technologies are growing in prevalence. In particular, the unauthorized transmission of data has become more prevalent given the proliferation of wireless technology. Ad-hoc networks, where individual users communicate with each other directly without using intermediary network nodes, create new susceptibilities to the users and networks. These susceptibilities can be categorized as “trust”, “rights”, “identity”, “privacy” and “security” related issues.

“Trust” refers to the assurance that information communicated in these systems can be shared. To illustrate, a wireless user may want to know that a communication was sent to it from a trusted source and using trusted communication nodes. The user in an ad-hoc network may have no knowledge that the communication was transferred over a hacker's wireless device with packet sniffing software. Additionally, with the use of tunneling, intermediate nodes transferring the communication may be transparent to the wireless user.

“Rights” (“rights management”) refers to the control of data. To illustrate, one wireless user may have limited rights in a wireless system. However, if that user colludes (knowingly or unknowingly) with a second node having superior rights, that user may gain rights above those that the user is allowed.

“Identity” refers to the control linked to the identity of the wireless user. To illustrate, a rogue wireless device may attempt to access a wireless network by pretending to be an authorized user of the network, by using that authorized user's identity. “Privacy” refers to maintaining privacy of the individual, data and context. A wireless user may not want others to know, which web sites he/she visits and, in particular, information sent to these sites, such as financial, medical, etc. “Security” refers to the security of the data and context, such as preventing an unauthorized individual access to a wireless user's information.

To reduce the susceptibility of wireless networks, techniques such as wired equivalent privacy (WEP), Wi-Fi Protected Access (WPA), Extensible authentication Protocol (EAP), IEEE 802.11i and GSM based encryption are used. Although these techniques provide some protection, they are still susceptible to the trusts, rights, identity, privacy and security issued. To illustrate, although a particular wireless communication node may have the correct WEP keys to communicate with a wireless user, that user may not know whether he/she can “trust” that node.

There are several techniques by which additional data can be embedded into the digital representation of such cover signals, without producing noticeable perceptual quality degradation. Such a watermarked cover signal is stored or transmitted to be ultimately received by a receiver. The received watermark signal is, in general, a corrupted version of the original watermarked cover signal, either intentionally by an attacker or unintentionally by the storage or transmission technologies. The receiver attempts to recover the embedded watermark by appropriate signal processing. The recovered watermark may be used for a variety of purposes, such as identifying the owner of the multimedia content.

It is therefore desirable to have viable approaches to watermarking data being communicated over wireless communications.

### SUMMARY

In a communication system comprising a plurality of transmit/receive units (TRUs), a method and apparatus for embedding a watermark into data wherein a carrier signal containing data is modified to embed watermark information. The modified carrier signal is transmitted. A receiver receives the modified carrier signal and extracts the watermark information from the modified carrier signal.

### BRIEF DESCRIPTION OF THE DRAWINGS

The foregoing summary, as well as the following detailed description of the preferred embodiments of the present invention will be better understood when read with reference to the appended drawings, wherein:

FIG. 1 is an illustration of a traditional digital communication transmitting system;

FIG. 2 is an illustration of a watermarking digital communication transmitting system;

FIG. 3 is a simplified block diagram of watermarking wireless communications;

FIG. 4 is a simplified flow diagram of watermarking wireless communications;

FIG. 5 is a simplified block diagram of a transmitting TRU using delay transmit diversity watermarking;

FIG. 6 is a simplified block diagram of a receiving TRU for use in receiving delay transmit diversity watermarking;

FIG. 7 is a functional block diagram depicting the modulation of a sinusoidal carrier signal;

FIG. 8 is a functional block diagram depicting a voice watermarking system;

FIG. 9 is a functional block diagram of a watermarking system in accordance with an embodiment of the present invention;

FIG. 10 is a functional block diagram of a pair of transmit/receive units (TRUs), configured to transmit/receive watermarked data in accordance with the present invention; and

FIG. 11 is a flow diagram depicting a process for watermarking and transmitting data in accordance with the present invention.

### DETAILED DESCRIPTION OF THE PREFERRED EMBODIMENTS

Hereafter, a wireless transmit/receive unit (WTRU) includes but is not limited to a user equipment, mobile station, fixed or mobile subscriber unit, pager, station (STA) or any other type of device capable of operating in a wireless environment. When referred to hereafter, a base station includes but is not limited to a Node-B, site controller, access point or any other type of interfacing device in a wireless environment. When referred to hereafter a transmit/receive unit (TRU) includes a WTRU, base station or a wired communication device.

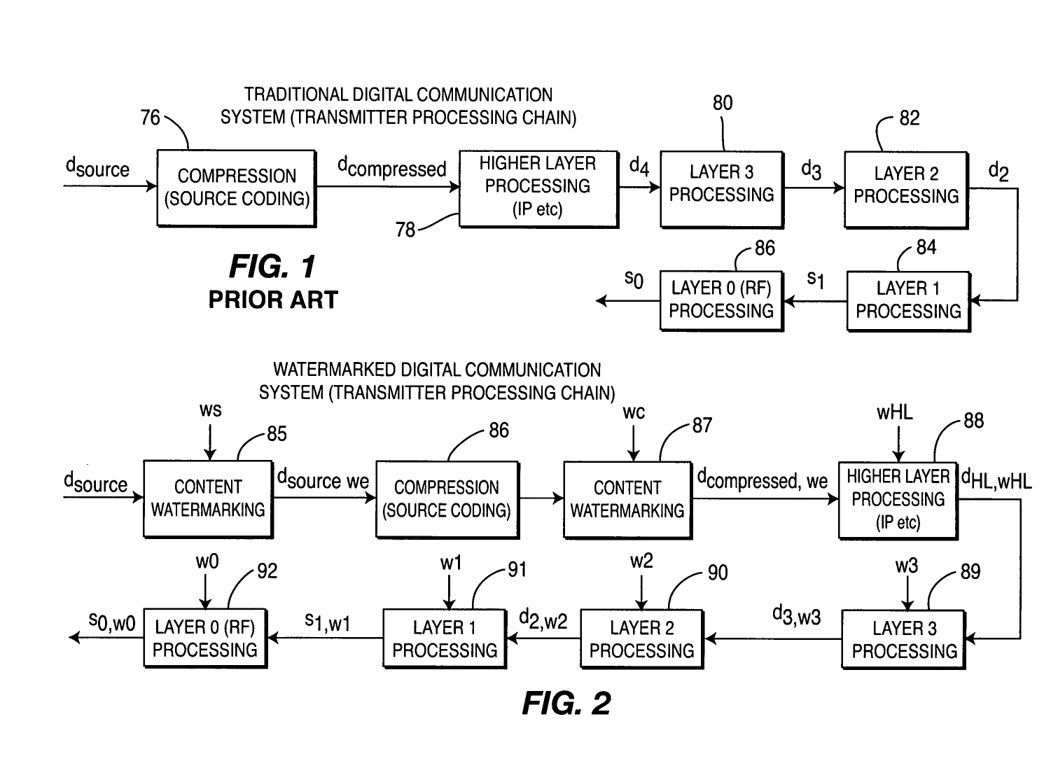

Referring to FIG. 1, in a traditional digital communication system, the source data is d_{source}, such as binary data. This data could represent digitized speech or image or video signals or binary text or other digital data. This data is sometimes compressed (through a process called source coding) 76 producing a compressed binary data stream, denoted as d_{compressed}. The compressed data is processed by higher OSI layers (such as HTTP, TCP, IP layers etc) 78 producing a binary data denoted as d_{HL}. The resulting data is now processed by the OSI layers belonging to the Radio Interface, namely Layer 3 80, Layer 2 82, Layer 1 84 and RF layer 86. As denoted in FIG. 1, these are denoted as d₃, d₂, s₁, and s₀, respectively. d₃, d₂, are binary data, whereas s₁, and so are analog signals. In the receiver side, the processing is performed similarly, but in a reverse order (RF followed by Layer 1, followed by Layer 2, followed by Layer 3, followed by Higher layers and then decompressed).

For the following (excluding claims), ‘data’ and ‘signals’ refer to ‘binary data’ and ‘analog signals’ respectively, unless otherwise noted.

FIG. 2 shows digital communication link processing chain modified to embed watermarks/signatures into the communicated (binary) data and/or (analog) signals. Watermarking involves binary watermark data w, cover data or signal d or s, a watermark embedding scheme/algorithm E and a watermarked data/signal d_{w} or s_{w}, such as per Equation 1.
s_{w}=E{s,w} or d_{w}=E{d,w} Equation 1

The binary watermark data may be generated by digitizing an analog watermark signal. For example, the finger print or a handwritten signature is an analog signal, that can be digitized to produce binary watermark data.

Since Embedding allows the watermark to be communicated along with the main source data, the embedding scheme may also be viewed as defining (perhaps implicitly) an Embedded Channel into the source data itself. As such, the embedding scheme may be said to define ‘watermarking channels’ or ‘embedded radio channels’. If these channels are defined at the Layer 1 or RF Layer, the corresponding embedded radio channels may also be referred to as ‘Embedded Physical Channels’.

The watermark/signature can be embedded in the content 85, 86 (ws), prior to or after compression 86; embedded during higher layer processing 88 (wHL); embedded during Layer 3 89 (w3), Layer 2 90 (w2), Layer 1 91 (w1) and Layer 0 (RF) 92 (w0).

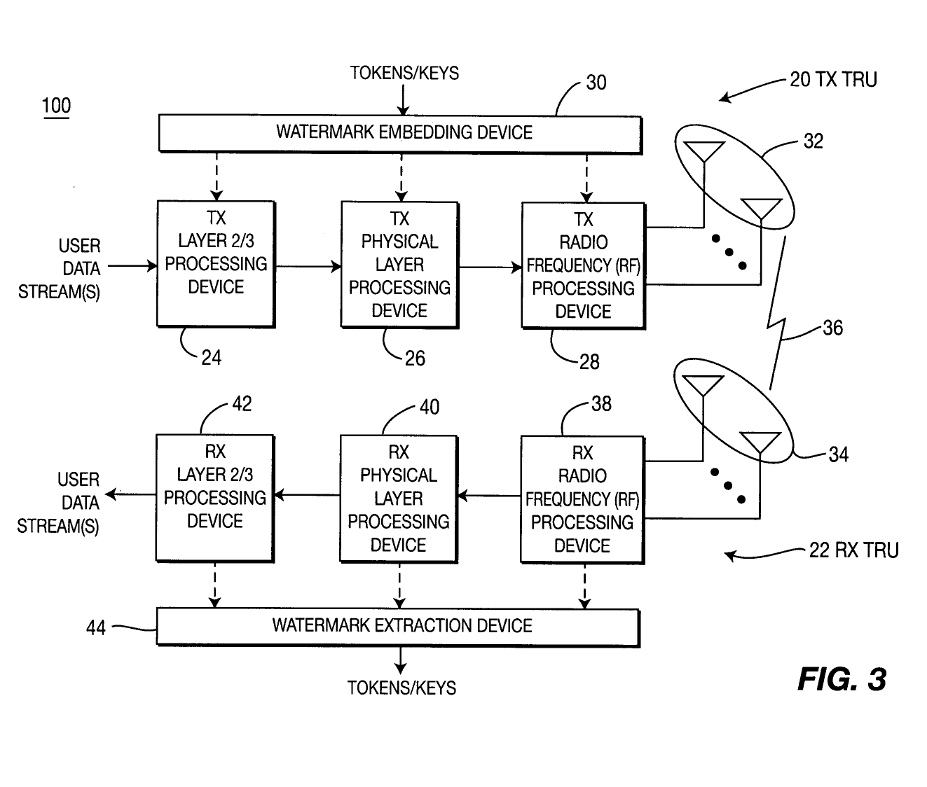

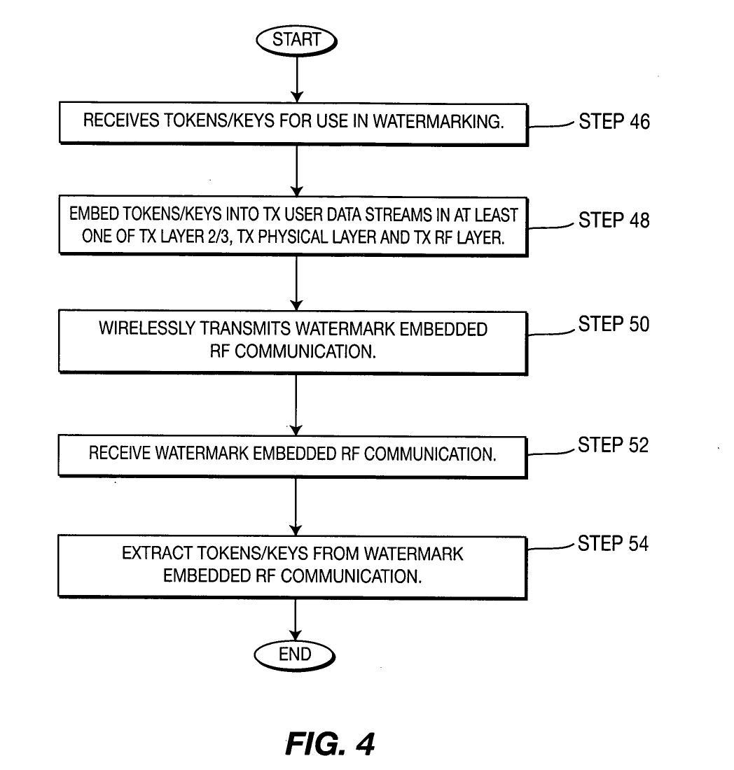

Although the following refers to watermarks, signatures may be used instead of watermarks in the same context for wireless communications. FIG. 3 is a simplified diagram of watermarking wireless communications and is described in conjunction with FIG. 4 which is a simplified flow diagram for watermarking wireless communications. A transmitting (TX) TRU 20 receives user data stream(s) for wireless communication to a receiving (RX) TRU 22. The user data streams are processed using a TX layer 2/3 processing device 24 to perform layer 2/3 (data link/network) processing. Although the layer 2/3 processing is illustrated as occurring in the TRU for both the TX 24 and RX 42, it may alternately occur in other intermediate network nodes. To illustrate, in a universal mobile terrestrial system (UMTS) communication system, the layer 2/3 processing may occur within a radio network controller, core network or Node-B.

The layer 2/3 processed data is physical layer processed by a TX physical layer processing device 26. The physical layer processed data is processed for radio transmission by a TX radio frequency (RF) processing device 28.

The TX TRU 20 (or alternate network node) receives tokens/keys for producing watermarks (step 46). The tokens/keys are processed by a watermark embedding device 30, which embeds the tokens/keys as a watermark in any one or across multiple ones of the layer 2/3, physical or RF layers (step 48). The watermark embedding device 30 may also perform encoding and/or modifying of the tokens/keys, before embedding them, in order for them to be robust or a better fit into the processed user data stream(s).

The watermark embedded RF communication is radiated by an antenna or an antenna array 32 (step 50). The embedded communication is received over the wireless interface 36 by an antenna or antenna array 34 of the receiving (RX) TRU 22 (steps 52). The received communication is RF processed by a RX radio frequency processing device 38. The RF processed communication is physical layer processed by a RX physical layer processing device 40. The physical layer processed data is layer 2/3 processed by a RX layer 2/3 processing device 42 to produce the user data stream(s). During any one or across multiple ones of the radio frequency, physical layer or layer 2/3 processing, the embedded watermark is extracted by a watermark extraction device 44 (step 54), producing tokens/keys such as for use in authentication and other trust, rights, identity, privacy or security purposes.

Using watermarks at lower layer of the open systems interconnection (OSI) model provides potential advantages. Authentication of wireless communications can occur at lower OSI layers and undesired communications can be identified at these lower layers. As a result, these communications can be discarded or blocked from being processed by higher abstraction layers eliminating unnecessary higher layer processing and freeing up resources. Additionally, since these undesired communications may not be passed to higher layers, certain attacks on the wireless system can be prevented, such as denial of service attacks.

Lower layer authentication also provides added security for the wireless communications. Lower layer authentication tends to authenticate specific wireless links. As a result, unauthorized individuals not using proper links can be identified, which is more difficult and sometimes impossible to achieve at higher abstraction layers. To illustrate, one authorized user may provide a second user with a user name and password to allow the unauthorized user access to a secure wireless network. If the unauthorized user is not aware of a required wireless watermark or does not have the hardware/software to generate such a watermark, the unauthorized user will not be allowed access to the secure wireless network, although that user is using a legitimate user name and password.

Embedded Physical Channels

Two primary techniques are used to create the watermarked wireless communication: first, using a newly defined watermarking channel embedded in physical channel(s) or second, imprinting the watermark directly into existing radio channel(s). In the first technique, a new channel is defined to carry the watermark. These watermark channels are embedded in radio channels. To illustrate, one technique to produce such a channel is to slowly differentially amplitude modulate radio channel(s) to produce a new watermark channel co-existing with the existing channel(s). Watermarks are carried by these channels. This technique can be modeled as follows. The existing radio channel(s) can be viewed as a cover signal s. The watermark is w, an embedding function is E and the embedded channel is EPCH. The EPCH creation techniques are described subsequently. The watermarked signal s_{w} is per Equation 2.
s_{w}=E_{EPCH}{s,w} Equation 2

To enhance security further, the embedded channels may be encrypted to prevent a rogue TRU from being able to copy the watermark, if the rogue TRU is somehow aware of the embedded channel. These embedded channels may be used to carry security related data from higher OSI layers. To illustrate, encryption and other keys from higher layers are carried by the embedded channel. Other data carried on these channels may include “challenge words”, so that a TRU can authenticate itself when challenged by another TRU or the network.

The embedded channels preferably occur on a long-term continual basis; although non-continuous and short term embedded channels may be used. In some implementations, the watermarking channels operate on their own without data being transmitted on the underlying radio channel(s). As a result, underlying channel(s) may be needed to be maintained, when it has no data to transmit. The radio channel can be viewed as a cover work for the watermarking channel. Preferably, the data transmitted on the cover work radio channel is typical of data transmitted on the channel. The existence of uncharacteristic data on the channel, such as a long run of zeros, may draw an eavesdroppers attention to that channel. Such data preferably mimics data actually send on the channel, which makes it difficult for the eavesdropper to ascertain when cover data is being transmitted. Alternately, a random bit pattern may be used on the cover channel. For encrypted or scrambled channels, a random bit pattern may provide adequate security for some implementations.

In a military application, the cover data transmitted may be misleading information (misinformation). If an enemy unit encounters the communication node transferring the cover information, the enemy may leave the node intact as to attempt to decode the misleading data or cover data. In one embodiment, the generation of appropriate quality cover data is preferably automated, as manual operations to produce such data may be prone to errors and may be difficult to implement.

Multiple watermarking channels can be used to increase the overall bandwidth of the composite watermarking channel. The use of multiple channels allows for watermarking information having a bandwidth greater than the capacity of one watermarking channel to be transferred. To further enhance security, when multiple watermarking channels are utilized, the watermarking data hops the channels in a predetermined pattern. As a result, an eaves dropper monitoring one channel may only have access to a portion of the watermark data.

The embedded radio channels can be used to allow security operations to be performed in a manner transparent to higher layers. As a result, added security can be achieved without modification to higher layer software and applications and without a change in the operational load of these layers.

Watermarking Physical Channels

In the second technique, the watermark is embedded (imprinted) into the radio channel. To illustrate, synchronization bits or unused bits in radio channel can be varied to effectively carry the watermark in that radio channel. This technique can be modeled as follows. The existing radio channel(s) can be viewed as a cover signal s. The watermark is w, an embedding function is E and a secret key is k. The secret key k can be viewed as the specific radio channel embedding technique, which are described subsequently. The watermarked signal s_{w} is per Equation 3.
s_{w}=Eₖ{s,w} Equation 3

The watermarked signal s_{w} is preferably robust with respect to common signal processing operations, such as filtering, compression or other typical wireless network functionalities. It is also desirable that the watermarked signal s_{w} be imperceptible. The use of the watermark does not impact the operation of the wireless system in a perceptible manner. To illustrate, components of the wireless system not aware of the watermark can process the wireless communication without a hardware or software modification. Additionally, if the watermarking technique is publicly known, it is desirable that a form of secure key is used to secure the exchange.

Both techniques can be used in conjunction with intruder detection operations. One embodiment to handle intruder detection is to force TRUs to re-authenticate with a new authentication key and re-associate with the wireless network. Another approach is to manipulate the WEP or other key so that the authorized users can re-authenticate, but no TRU can transmit data until re-authenticated.

Watermarking Techniques

The following are different techniques for watermarking. These techniques can be used with many wireless systems, such as analog, digital, GSM, UMTS W-CDMA (FDD, TDD and TD-SCDMA), CDMA2000, IEEE 802.11a, b, g and n, IEEE 802.15, IEEE 802.16, Bluetooth, among others. Although described as different techniques, these techniques can be combined in various manners. To illustrate, some wireless systems may use both orthogonal frequency division (OFDM) and code division multiple access (CDMA). Accordingly, a combination of OFDM and CDMA related techniques may be used.

Error Correction Codes

Most wireless communication systems utilize error detection/correction coding. These techniques are adapted to carry watermarks/watermark channel. One technique uses puncturing to carry watermark information. In many wireless systems, puncturing is used to reduce the number of data bits to a specified number and for other purposes. The pattern of the puncturing is changed to indicate a watermark. Each change in the puncturing pattern represents bits of the watermark. Additionally, the data stream may have added more redundancy than traditionally used and the additional bits are punctured in a pattern to carry the watermark. To illustrate, data may be encoded at a 1/3 or 1/4 forward error correction (FEC) rate and punctured down to a traditional 1/2 FEC rate.

Another technique for transferring a watermark by error correction codes is by initializing a FEC shift register with the watermark prior to channel coding of the data stream. Similarly, a shift register for use in producing a circular redundancy check (CRC) code is initialized by the watermark. The redundant bits of the FEC code are replaced with bits relating to the watermark. The transmit and receive TRU will have knowledge of which redundant bits are being replaced. The FEC tail bits are modified to embed the watermark in those bits. Additionally, the watermark can be masked onto FEC outputs, CRC outputs, and convolutional and turbo coded information. Typically, the watermark is modulo-2 added to the FEC output, CRC output, convolutional and turbo coded information. If the length of the watermark is not the same as the information being masked, the watermark may be applied to only a portion of the information/output, padded by zeros, pruned or repeated.

Channel Coding

Many wireless channels use channel coding for identification, for distinguishing communications, for removing a bias in data sequences and other purposes. Watermarks can be carried using these codes. In many wireless systems, scrambling codes and other codes are used. The watermark is embedded in these codes. Bits of the code are changed to embed the watermark in the code. The changed bits can be at the beginning of the code sequence, in a segment of the code sequence or throughout the entire code sequence. For heavily coded (highly redundant) communications, the information will be readable, although a small degradation in signal to interference noise ratio (SINR) may occur, due to the changed bits.

Alternately, the polynomial used to generate some codes is modified to identify the watermark. The values of the polynomial include the watermark data. This watermarked polynomial can be used for the whole sequence or a small specified portion, such as in a preamble, midamble or tail.

Many wireless systems have flexible/adaptive modulation and coding schemes. The type of modulation and coding is varied to identify bits of the watermark. To illustrate, a transmitting TRU may switch between QPSK and 16-QAM to indicate bits of a watermark.

Message Bit Manipulation

Many wireless systems have unused bits/symbols (such as reserved for future use) and unused time intervals. Watermark bits are inserted into these unused bits and time periods. To illustrate, frequently in rate matching bits may be added to data to meet a specified number of symbols or bits. A watermark is used for these bits instead of zero padding or repeating prior bits/symbols.

Alternately, used bits/symbols are used to carry watermark bits, such as pilot, control and message. At predefined positions within this data bits are modified to carry the watermark. Another technique to carry watermarks phase rotates symbols, such as the symbol constellation. These changes occur slowly over time. The change in the phase indicates bits of the watermark.

Miscellaneous Physical/RF Techniques

In many wireless communications, pulse shaping and spectrum shaping filters are utilized. The coefficients used in the pulse/spectrum shaping are modified to carry a watermark. The selection of the set of coefficients to generated the pulse/spectrum shape carry the watermark. A receiving TRU analyzes the shape of the received pulse/spectrum to determine which coefficients were used for transmission. To illustrate, if N sets of coefficients are used to produce allowable pulse/spectrum shapes, up to log₂ N bits of a watermark can be distinguished by each coefficient set selection.

It is generally desirable in wireless communications to have precise transmit modulation to aid in precise demodulation at the receiving TRU. To illustrate, in QPSK modulation, typically the four potentially transmitted constellation values can be viewed as points and are typically at values (1+j, 1−j, −1+j and −1−j). These values can be offset to indicate watermark bits/symbols or these values may not form precise points, such as forming small curves instead of a precise point value, identifying watermark bits.

In many wireless communication systems including 3GPP and 3GPP2, for a user data stream transmission, there are several possible combinations of the physical layer parameters such as FEC type, FEC coding and modulation type. In 3GPP, these parameters are referred to as transport format configuration (TFC). The selection of the TFC to transmit a data stream carries the watermark.

RF Related

To indicate bits of a watermark, the carrier frequency is adjusted. These adjustments preferably occur in certain time intervals so that they are distinguishable from Doppler shifts and other carrier frequency drift. The amount of the adjustment is an indication of bits of the watermark. To illustrate, the carrier can be adjusted by increments of hundreds or thousands of Hertz (Hz).

Jitter is a problem dealt with in communications. A watermark can be imprinted on a signal by creating an artificial jitter. To illustrate, a slow scrambling code jitter is introduced with respect to the carrier frequency. The watermark information is effectively frequency shift keying modulated on top of the jitter.

To carry watermark bits, the temporal and delay characteristics of a channel are modified. To illustrate, the transmission of data is artificially delayed to indicate bit(s) of a watermark. In CDMA type systems, such a delay may occur in the channelization code. Also, the difference between the delays of codes can be used to indicate bits of a watermark.

Antenna Related

In multiple input/multiple output (MIMO) communications, the MIMO channel as produced by the various antenna elements can be viewed as a spatial spreading function. The transmitted MIMO waveform is modified to indicate bits of a watermark. To illustrate, during open loop spatial spreading, a matrix, such as a Hadamard matrix, is used to carry bits. A specific rotation sequence used in the spatial spreading is used to carry the watermark. One approach to do this is to use a hardware version of a Shelton-Butler matrix instead of a Hadamard matrix. Switching to a different matrix input or output port automatically changes the phase rotation sequence, creating a watermark.

Another technique for sending a watermark uses antenna polarization. The polarization of an antenna or antenna array is varied to modulate bits to provide a watermark. To illustrate, the polarization is varied in a synchronized pseudo-random manner.

In transmit diversity, various coding techniques are used, such as space time block coding (STBC) and space frequency block coding (SFBC). The coding of these symbols are modified to carry watermark bits. To illustrate, the symbols of every other symbol period may embed a bit of a watermark by an inversion or non-inversion.

Delay Transmit Diversity

In wireless systems, a wireless channel is modified such that a received channel delay profile is modified to be the information-carrying medium for a watermark. In a receiver, the watermark is extracted and decoded by an extension of the channel estimation to extract the channel delay profile characteristics that carry the watermark.

A propagation channel's characteristics are used to embed the watermark. As a result, the watermark is very difficult to detect or circumvent if either the watermark is not known, or the receiver is not aware of the technique being used. In addition, this technique provides for a receiver that does not have knowledge of a watermark to operate without this added information being decoded. Specifically, existing infrastructure equipment would still work with this technique.

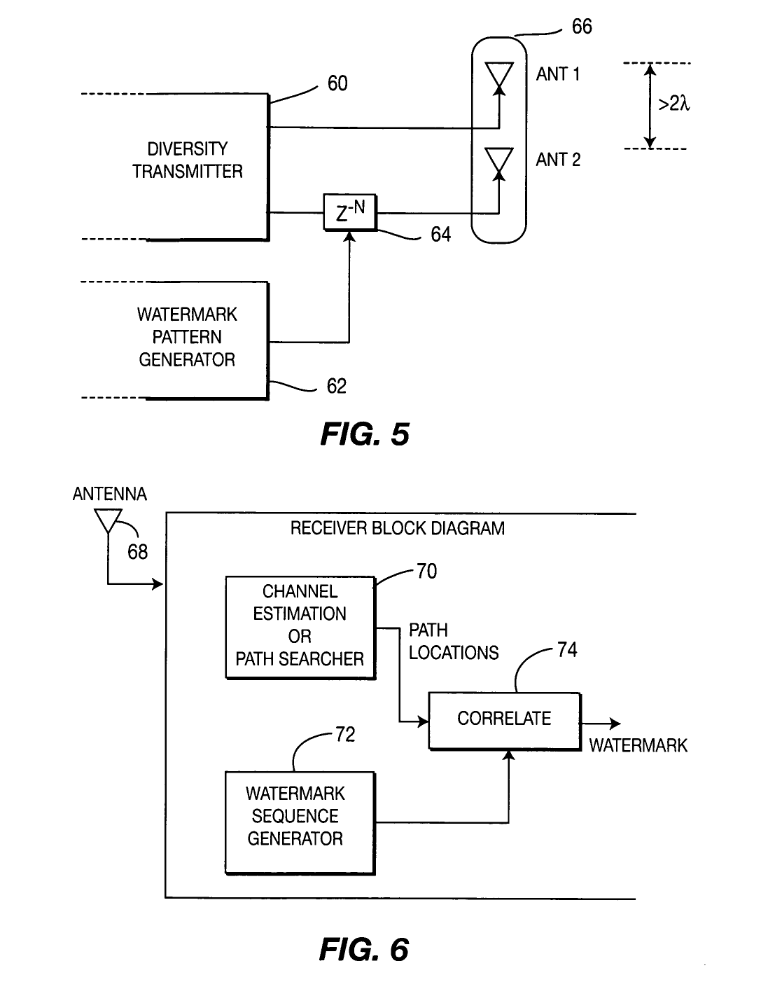

One embodiment of this technique is illustrated in FIGS. 5 and 6. FIG. 5 is a simplified block diagram of a transmitting TRU. A diversity transmitter 60 may be any suitable transmitter which includes a provision for transmitting on diversity antennas. Specifically, it should contain two separate transmit chains. The diversity transmitter 60 incorporates a variable (adjustable) delay 64 that is modulated in such a manner as to cause the relative delays of the second antenna to be equal to values of the watermark bits. Although illustrated using two transmit antenna 66, the embodiment can be extended to any number of antenna elements by adding additional delays.

A watermark pattern generator 62 produces a watermark sequence, such as a pseudo-random sequence. The delay device 64 delays the signal transmitted on an antenna element relative to a reference antenna element, in response to the watermark pattern. To illustrate, the delay can be controlled in multiples of a chip or symbol, and is preferably adjusted such that the mean delay a is greater than the (or some multiple of the) coherence bandwidth of the channel.

Transmit antennas 66 are sufficiently uncorrelated to ensure that the signals exhibit diversity relative to each other. This may be accomplished by suitably separating the antennas, utilization of polarization antennas, or directional antennas. Preferably, the antennas are spaced at a value greater than twice the carrier wavelength, although lesser spacing may be used.

Although this technique is illustrated as being employed on multiple antennas, it can be employed on a single antenna. Both the delayed and undelayed data streams can be combined and radiated on a single antenna. In such a configuration, the delay between the streams is selected so as to allow for distinguishing of the two signals. As a result, the second stream creates an artificial multipath with respect to the receiving TRU. Specifically, the delay is adjusted such that the mean delay a is greater than the (or some multiple of the) coherence bandwidth of the channel.

FIG. 6 illustrates a receiving TRU. The receive antenna 68 or array receives the wireless transmission. Channel estimation or path searcher device 70 (referred to as channel estimation subsequently) is a technique used to identify the channel tap coefficients or delay paths. The spread in time of the delay paths is referred to as the delay spread of the channel.

A watermark sequence generator 72 is used to locally generate a private copy of the reference watermark (or key) to compare (or correlate) the received watermark against. A local private copy may also be derived by some other means for example from a copy that is stored on a subscriber information module (SIM) card for a global system for mobile (GSM) phone.

A correlator 74 is used to compare the received watermark (within the channel estimate) against the local private copy. If the correlation is high (above a specified threshold, e.g. >0.9), the received watermark is deemed to be intended for the recipient.

Transport Watermarking

Another embodiment of the present invention relates to transport watermarking via modulation of rich carriers.

For example, as described earlier, in an Amplitude Modulation system, it is possible to alter the carrier frequency within certain limits without degrading the overall communication significantly. Based on this property, Transport Watermarking (TWM) may be achieved by the extra data to be embedded by deliberately varying the carrier frequency. In a similar manner, other Layer-1 Baseband processing functions may be modified by the extra data to be embedded and thus watermarking the primary communicated signal.

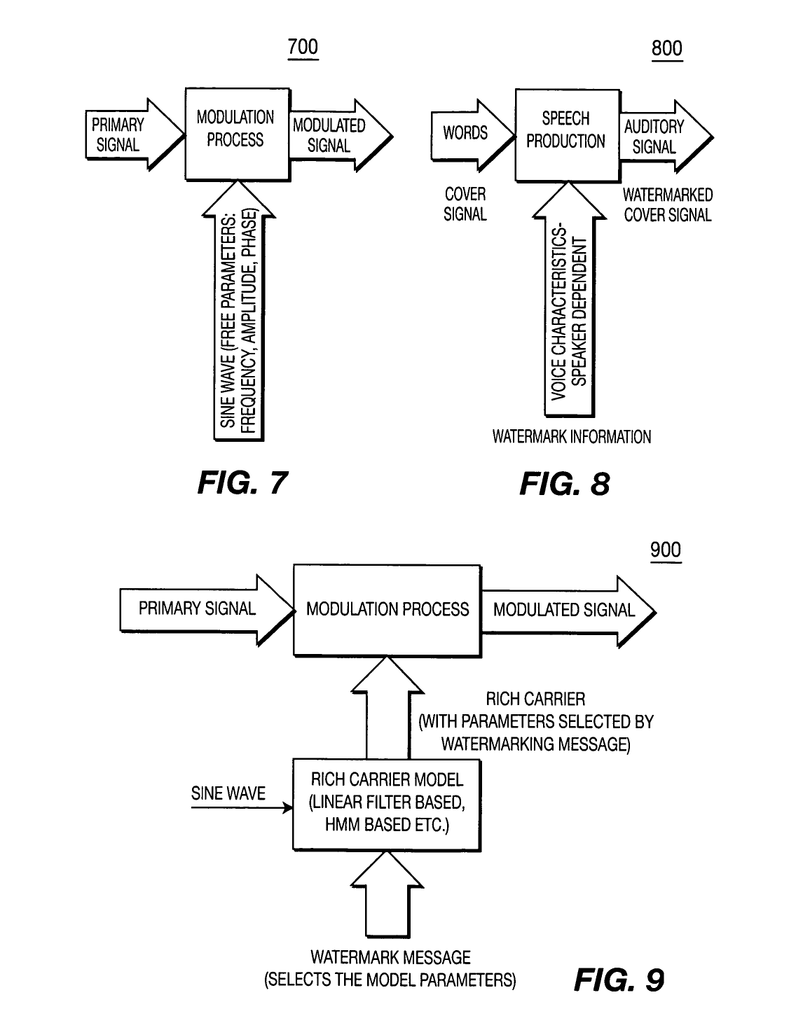

Transport Watermarking (TWM) typically refers to embedding extra data into a transport level communication stream. For example, considering the Layer-1 Baseband processing of a radio modem transmitter, one of the functions involved is modulation of a sinusoidal carrier signal. FIG. 7 is a functional block diagram depicting the modulation of a sinusoidal carrier signal 700.

For example, referring to FIG. 7, in an Amplitude Modulation system, it is possible to alter the carrier frequency within certain limits without degrading the overall communication significantly. Based on this property, Transport Watermarking may be achieved by the extra data to be embedded deliberately varying the carrier frequency. In a similar manner, other Layer-1 Baseband processing functions may be modified by the extra data to be embedded and thus watermarking the primary communicated signal. Such techniques can also be extended to Layer-0 RF & Antenna Processing, Layer-2 and Layer-3 processing functions, producing L0, L2, L3 TWM methods.

This sinusoidal carrier system is analogous to human voice communications, and can be exploited in relation to a TWM method. Consider words being communicated by different speakers. For a listener, all the speakers convey the same words, but each of the auditory signals is different. In fact, each auditory signal conveys precise information about the particular speaker, to the extent that the listener can actually determine the speaker by the voice characteristics, despite the fact that the words spoken are identical. Thus, the words being spoken are analogous to the cover signal/data and the specific voice characteristics are analogous to the extra watermark information. FIG. 8 is a functional block diagram depicting an analogous voice watermarking system 800.

Much in the same way that two separate people can speak the same exact words (data) and a listener can determine the source of the communication by recognizing the voice of the speaker, a TRU may alter the carrier frequency of signals containing the same data and have a receiving TRU recognize the transmission source. This may be achieved by replacing a simple sinusoidal carrier signal with a richly structured carrier signal, thereby watermarking the signal. Importantly, any new structure embedded into a carrier waveform should adhere to the transmission requirements in terms of carrier phase and frequency jitter, frequency accuracy, amplitude, and the like.

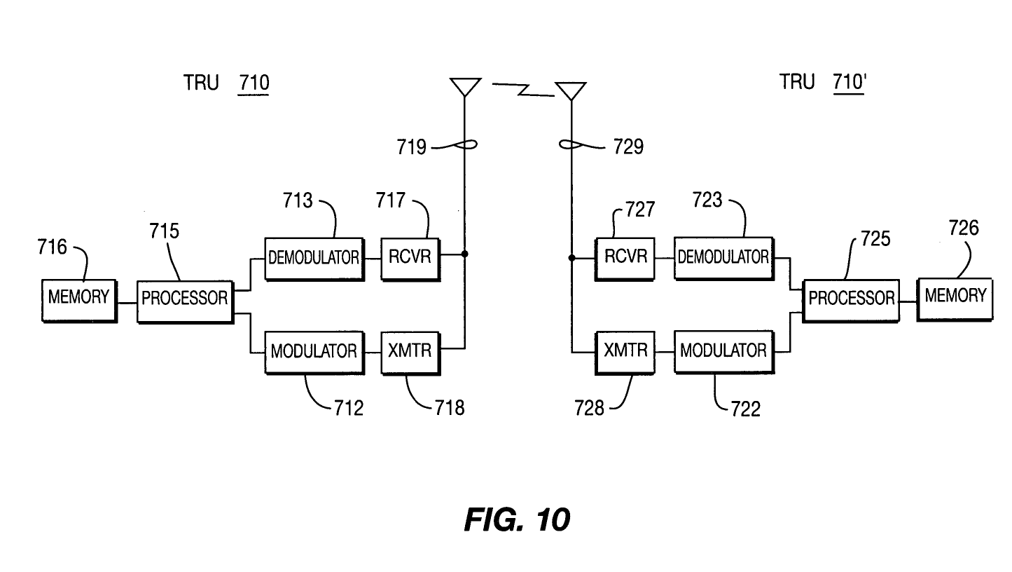

FIG. 9 is a functional block diagram of a watermarking system 900, in accordance with an embodiment of the present invention and FIG. 10 shows a pair of TRUs (designated TRU 710 and TRU 710′) configured to transmit and receive a signal with an embedded watermark in accordance with the present invention. For purpose of example, the TRU 710 is depicted as a transmitting TRU, while the TRU 710′ is depicted as a receiving TRU. However, either TRU is capable of transmitting or receiving a signal containing an embedded watermark.

In addition to the typical components included in a typical TRU the TRU 710 includes a processor 715 configured to embed a watermark onto a communication signal, a modulator 712 in communication with processor to modulate a signal received from the processor 715, a memory 716 in communication with the processor 715, a transmitter 718 in communication with the modulator 712 for transmitting data over a wireless medium, an antenna 719 in communication with the transmitter 718 to facilitate the transmission and reception of wireless data to and from the TRU 20, a receiver 717 in communication with the antenna 719 for receiving data wirelessly from the antenna 719, and a demodulator 713 in communication with the receiver 717 and the processor 715 for demodulating a signal received from the receiver 717.

In addition to the typical components included in a typical TRU the TRU 710′ includes a processor 725 configured to extract a watermark from a communication signal, a modulator 722 in communication with processor to modulate a signal received from the processor 725, a memory 726 in communication with the processor 725, a transmitter 728 in communication with the modulator 722 for transmitting data over a wireless medium, an antenna 729 in communication with the transmitter 728 to facilitate the transmission and reception of wireless data to and from the TRU 710′, a receiver 727 in communication with the antenna 729 for receiving data wirelessly from the antenna 729, and a demodulator 723 in communication with the receiver 727 and the processor 725 for demodulating a signal received from the receiver 727.

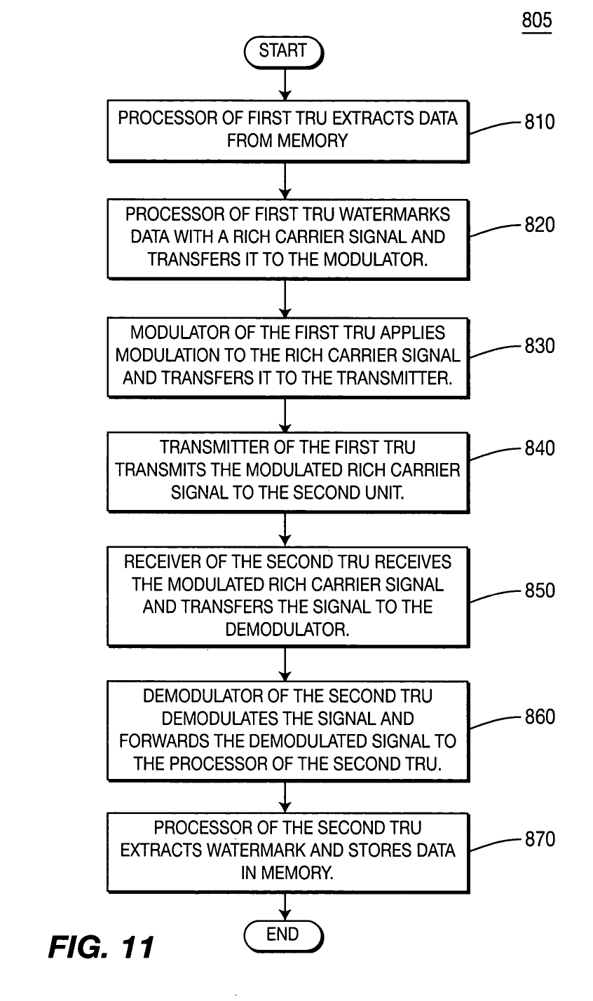

FIG. 11 is a flow diagram of a process for transmitting and receiving watermarked data 805 in accordance with the present invention. In step 810, the processor 715 of the TRU 710 extracts data from the memory 716 for transmission. Additionally, the processor 715 may extract instructions stored in the memory 716 describing how to introduce the rich carrier signal to the data. The processor 715 then introduces the rich carrier signal to the data to embed a watermark onto the data and transfers the watermarked data to the modulator 712 (step 820). One way in which the processor 715 may introduce a rich carrier signal to the data is through the introduction of intentional phase and frequency jitter into the carrier signal, while the underlying watermarking signal is contained in a spread spectrum manner. Since the transmit requirements in a wireless communication system are typically tight, the amount of jitter that may be introduced into the carrier signal should be slight. Accordingly, the processor 715 may encode the watermark signal by introducing a series of many small perturbations/jitters into the carrier signal to create the rich carrier signal. In this manner, the rich carrier becomes the embedded watermark on the data.

Alternatively, for an On-Off keying modulation process, the carrier signal may be modified by utilizing a linear filter with impulse response coefficients as the watermarking parameters. The filter in a preferred embodiment is excited by a periodic impulse train or white noise. In another alternative embodiment, the carrier signal may also be modified by introducing a Hidden Markov Model (HMM) to the carrier signal.

The rich carrier signal is applied to the modulator 712 which modulates the rich carrier signal and transfers it to the transmitter 718 (step 830), which transmits it to TRU 710′ (step 840). The modulator 712 may modulate the rich carrier signal by a variety of means, such as Bi-Phase Shift Keying (BPSK), Quadrature Phase Shift Keying (QPSK), Quadrature Amplitude Modulation (QAM) or any other type of modulation.

The receiver 727 of the TRU 710′ receives the rich carrier signal and forwards it to the demodulator 723 (850), which demodulates the rich carrier signal and forwards it to the processor 725 for processing (860). The processor 725 extracts the rich carrier and the watermark from the data and may store the data in the memory 726 (step 870). The processor 725 may extract information describing how to extract the watermark from the memory 726 during processing. In this way, the processor 725 must be familiar with the rich carrier coding utilized by the TRU 710 in order to extract it.

To a receiver that is not familiar with the coding, the watermark will simply appear to be noise. Accordingly, by introducing a rich carrier into the signal, it becomes possible to further enhance the security of the data since an unfamiliar receiver will not be able to demodulate the data without knowing the original coding.

For example, by introducing a frequency jitter into the carrier signal, a receiver not familiar with the watermark coding may interpret it as a Doppler spread, such as the kind that results from the relative motion of a transmitter, receiver and any reflectors contributing to the overall received signal. As a result, the receiver may break down or severely degrade in performance once the Doppler spread specification that the receiver is designed to deal with is exceeded. The frequency jitter can also be introduced specifically at a level that would exceed the specifications of normal receivers for lower relative velocities. Therefore, the transmitting receiver can exclude any receivers that are not aware of the watermark coding when those receivers are moving too fast with reference to their design parameter cutoff velocity or when the transmitter is moving too fast with reference to the receivers' design parameter cutoff velocity.

Although the figures of the application are illustrated as separate elements, these elements may be on a single integrated circuit (IC), such as an application specific integrated circuit (ASIC), multiple ICs, discrete components or a combination of discrete components and IC(s).

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a communication system comprising a plurality of transmit/receive units (TRUs), a method for embedding a watermark into data, the method comprising:
modifying a carrier signal containing data to embed watermark information;
transmitting the modified carrier signal;
receiving the modified carrier signal; and
extracting the watermark information from the modified carrier signal.

2. The method of claim 1 wherein the step of modifying a carrier signal containing data to embed a watermark includes introducing a jitter into the carrier signal.

3. The method of claim 2 wherein introducing a jitter into the carrier signal includes introducing a phase jitter.

4. The method of claim 2 wherein introducing a jitter into the carrier signal includes introducing a frequency jitter.

5. The method of claim 2 wherein introducing a jitter into the carrier signal includes introducing a plurality of small perturbations.

6. The method of claim 1, further comprising the step of modulating the modified carrier signal prior to transmitting the modified carrier signal.

7. The method of claim 6 wherein the step of modulating the modified carrier signal includes Bi-Phase Shift Keying (BPSK).

8. The method of claim 6 wherein the step of modulating the modified carrier signal includes Quadrature Phase Shift Keying (QPSK).

9. The method of claim 6 wherein the step of modulating the modified carrier signal includes Quadrature Amplitude Modulation (QAM).

10. The method of claim 6 wherein the step of modulating the modified carrier signal includes On-Off Keying.

11. The method of claim 10 wherein the step of modifying a carrier signal containing data to embed a watermark includes filtering the data through a linear filter.

12. The method of claim 11 wherein the filtering parameters are based on impulse response coefficients.

13. The method of claim 11 wherein the linear filter is excited by a periodic impulse train.

14. The method of claim 11 wherein the linear filter is excited by white noise.

15. The method of claim 10 wherein the step of modifying a carrier signal containing data to embed a watermark includes applying a Hidden Markov Model (HMM) to the carrier signal.

16. The method of claim 1 wherein the step of modifying a carrier signal includes modifying the carrier signal above a recognized tolerance threshold.

17. A transmit/receive unit (TRU), comprising:
a receiver;
a transmitter; and
a processor in communication with the receiver and the transmitter, wherein the processor is configured to modify a carrier signal containing data to embed watermark information and transmit the modified carrier signal.

18. The TRU of claim 17 wherein the processor is configured to introduce a phase jitter into the carrier signal.

19. The TRU of claim 17 wherein the processor is configured to introduce a frequency jitter into the carrier signal.

20. The TRU of claim 17, further comprising a modulator in communication with the processor and the transmitter, wherein the modulator modulates the modified carrier signal prior to transmission.

21. The TRU of claim 17, further comprising a memory in communication with the processor.

22. The TRU of claim 17 wherein the processor is configured to extract watermark information from a modified carrier signal.

23. The TRU of claim 17 wherein the TRU is a wireless TRU (WTRU).

24. In a communication system comprising a plurality of transmit/receive units (TRUs), each TRU including an integrated circuit (IC) comprising:
a receiver;
a transmitter; and
a processor in communication with the receiver and the transmitter, wherein the processor is configured to modify a carrier signal containing data to embed watermark information and transmit the modified carrier signal.

25. The IC of claim 24 wherein the processor is configured to introduce a phase jitter into the carrier signal.

26. The IC of claim 24 wherein the processor is configured to introduce a frequency jitter into the carrier signal.

27. The IC of claim 24, further comprising a modulator in communication with the processor and the transmitter, wherein the modulator modulates the modified carrier signal prior to transmission.

28. The IC of claim 24, further comprising a memory in communication with the processor.

29. The IC of claim 24 wherein the processor is configured to extract watermark information from a modified carrier signal.
